(19) United States
(12) Patent Application Publication
(10) Pub. No.: US 2004/0158389 A1
(43) Pub. Date: Aug. 12, 2004

(54) Information display system

(75) Inventors: Yumi Shibata, Okazaki-shi (JP); Toru Sakai, Okazaki-shi (JP); Kunihiro Yamada, Okazaki-shi (JP)

Correspondence Address: OLIFF & BERRIDGE, PLC, P.O. BOX 19928, ALEXANDRIA, VA, 22320, US

(73) Assignee: AISIN AW CO., LTD., ANJO-SHI (JP)

(21) Appl. No.: 10/736,599

(22) Filed: Dec. 17, 2003

(30) Foreign Application Priority Data
Dec. 17, 2002 (JP) 2002-364704

(51) Int. Cl. G01C 21/26

(52) U.S. Cl. 701/200

(57) ABSTRACT

An information display system capable of automatically acquiring necessary information from a facility information screen and registering the acquired information in an automotive navigation apparatus. The information display system includes a display for displaying a facility information screen, an information extractor for extracting position identification information from the facility information screen, a facility information registration unit for registering facility information including a specified point set on the basis of the position identification information, and a facility information storage unit for storing the registered facility information.

### CROSS-REFERENCE TO RELATED APPLICATION

The disclosure of Japanese Patent Application No. 2002-364704 filed on Dec. 17, 2002 including the specification, drawings and abstract are incorporated herein by reference in its entirety.

### BACKGROUND OF THE INVENTION

1. Field of Invention

The present invention relates to an information display system.

2. Description of Related Art

A known navigation apparatus for use on a vehicle, such as a car, searches an optimum route from a starting point to a destination based on road map data, and the resultant route is displayed on a display screen.

Navigation apparatuses have been proposed in which, if a destination and a scheduled date of a trip to a destination are registered in advance, a route to the destination is automatically searched when the registered date is reached, and the resultant route is displayed on a display screen (refer to, for example, Japanese Unexamined Patent Application Publication No. 11-51671).

In the use of this type of navigation apparatus, a user, such as a driver of a car, sets the navigation apparatus in terms of the destination, such as a resort, sightseeing spot, or other place to visit, and also in terms of the date of the scheduled trip, for example, the date of the next holiday. On that holiday, the navigation apparatus automatically searches a route to the destination and displays the resultant route on a display screen. This not only makes it possible for the user to know the optimum route to the destination but also prevents the user from forgetting the route contemplated by the user.

Navigation apparatuses have also been proposed which have a capability of being connected with the Internet. In such a navigation apparatus, a user can access a Web page or a home page via the Internet to acquire information about a facility available at the resort, sightseeing spot, or any other place to visit, or event scheduled to be held at such places.

General background art described above is disclosed in Japanese Unexamined Patent Application Publication No. 11-51671 which is incorporated herein by reference.

The known navigation apparatuses of the type described, however, involves a deficiency in that the user, when setting a destination based on information obtained through the Internet, is required to extract from the information acquired through the Internet, specific information that identifies the destination on the map. The user then operates the navigation apparatus to enter the information. Consequently, the task of setting the destination is considerably time-consuming and laborious.

For instance, when a navigation apparatus is connected to the Internet, and information associated with a facility to be set as a destination is searched for, the user has to first acquire information, such as an address or a telephone number, that identifies the position of the facility from a Web page. The user then inputs the acquired address or the telephone number into the navigation apparatus thereby setting the destination. That is, the user must perform many operations including, connecting the navigation apparatus to the Internet, searching the address or the telephone number of the destination, and inputting the address or the telephone number to the navigation apparatus, in order to set the destination on the navigation apparatus. To ensure that the address or the telephone number is correctly input without mistake, the user may have to take a memo of the address or the telephone number. Consequently, the user is encumbered by time-consuming and laborious work, from connecting the navigation apparatus to the Internet until the destination is safely set on the navigation system.

### SUMMARY OF THE INVENTION

In view of the above, it is an object of the present invention to provide an information display system capable of automatically acquiring necessary information from a facility information screen and registering the acquired information.

To achieve the above object, the present invention provides an information display system having, in combination, a display for displaying a facility information screen, an information extractor for extracting position identification information from the facility information screen, a search unit for searching for a facility corresponding to the position identification information, a facility information registration unit for registering the facility information including the position of the searched facility, and a facility information storage unit for storing the registered facility information.

In an exemplary embodiment of the present invention, the information display system has an information terminal which includes the display and a transmitter/receiver unit. The information display system also includes a server which includes the information extractor, the search unit, the facility information registration unit, the facility information storage unit, and a transmitter/receiver unit.

In another form of the present invention, the information display system has an information terminal including the display, the information extractor, the search unit, the facility information registration unit, and the facility information storage unit.

The position identification information may include, for example, a telephone number and/or an address. The facility information registration unit may verify the consistency between the telephone number and the address and set the position of the facility depending on the result of the verification of the consistency. The facility information may include, for example, a schedule in terms of a scheduled date/time.

The information display system of the invention may be arranged such that a notification of the schedule is given in advance. The arrangement also may be such that the schedule is deleted when the scheduled date/time expires. Alternatively, when a schedule expires, the scheduled date thereof may be updated.

### BRIEF DESCRIPTION OF THE DRAWINGS

FIG. 1 is a diagram showing a first example of a display screen of an information terminal according to a first embodiment of the present invention;

FIG. 2 is a conceptual diagram showing a construction of an information display system according to a first embodiment of the present invention;

FIG. 3 is a diagram showing a second example of the display screen of the information terminal according to the first embodiment of the present invention;

FIG. 4 is a flow chart showing a process of displaying information according to the first embodiment of the present invention;

FIG. 5 is a flow chart showing a process of extracting a telephone number according to the first embodiment of the present invention;

FIG. 6 is a flow chart showing a process of registering facility information according to the first embodiment of the present invention;

FIG. 7 is a diagram showing a first example of a display screen of an information terminal according to a second embodiment of the present invention;

FIG. 8 is a diagram showing a second example of the display screen of the information terminal according to the second embodiment of the present invention;

FIG. 9 is a flow chart showing a process of informing of a registered schedule according to a fourth embodiment of the present invention; and

FIG. 10 is a flow chart showing a process of changing a registered scheduled date/time according to a fifth embodiment of the present invention.

### DETAILED DESCRIPTION OF PREFERRED EMBODIMENTS

The present invention is described in further detail below with reference to preferred embodiments in conjunction with the accompanying drawings.

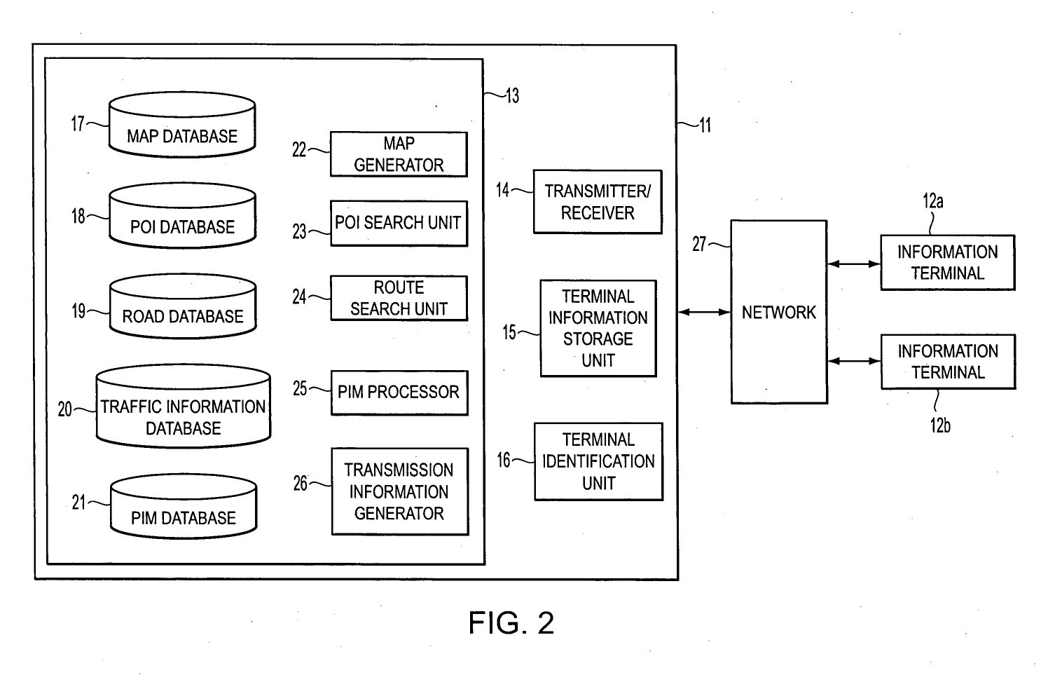

FIG. 2 is a conceptual diagram showing a construction of an information display system according to a first exemplary embodiment of the present invention.

Referring to FIG. 2, an information provider server 11, acting as the server in the present invention, is implemented on a computer which includes processor means, such as a CPU or an MPU, storage means, such as a semiconductor memory, a magnetic disk, or an optical disk, and a communication interface. The server is not necessarily implemented on a single computer but may be implemented in the form of a distributed server formed of a plurality of computers connected with each other. It is also to be noted that in addition to the server, another system may also be implemented on the same computer. Alternatively, the information provider server 11 may be implemented on another computer in a system.

Numerals 12a and 12b denote a first information terminal and a second information terminal to be operated by users. Note that an actual system includes a great number of information terminals which, for the sake of convenience in the explanation, are represented by information terminals 12a and 12b in the illustrated embodiment. Users may be any person, such as drivers or passengers of passenger cars, trucks, buses, or motorcycles, or walkers or passengers of public transportation systems.

Each of the information terminals 12a and 12b includes the following parts or components: a processor, such as a CPU or an MPU; a storage device, such as a semiconductor memory, a magnetic disk, or an optical disk; a display such as a liquid crystal display, an LED (Light Emitting Diode) display, or a CRT display; an input device, such as a keyboard, a joy stick, arrow keys, a push-button, a remote control, or a touch panel; a display controller for controlling the display; an audio output device, such as a speaker, an earphone or a headphone; and a transmitter/receiver unit, such as a communication interface.

Although the information terminals 12a and 12b are described in the context of a navigation apparatus mounted on vehicles such as a passenger car, a truck, a bus, or a motorcycle, they also may be in the form of a stationary telephone, a mobile telephone, a PHS (Personal Handy-Phone System) telephone, a portable information telephone, a PDA (Personal Digital Assistant) device, a personal computer, a game machine, a digital television set, or other similar devices.

The information terminals 12a and 12b may include a current position detector not shown in the drawings. In a case in which the information terminal 12a or 12b is a navigation apparatus, the current position detector may detect a current position by means of a GPS (Global Positioning System), a geomagnetism sensor, a distance sensor, a steering sensor, a beacon sensor, or a gyroscopic sensor. When the information terminal 12a or 12b is a mobile telephone or a portable information terminal, the position of a base station, with which the information terminal 12a or 12b is currently communicating, is detected and the detected position of the base station is employed as the current position of the information terminal 12a or 12b. Alternatively, a GPS receiver serving as a current position detector may be incorporated in a mobile telephone, an information terminal, or the like.

The information terminals 12a and 12b are connected to the information provider server 11 via a network 27 such that they can communicate with each other. The network 27 may be of any type, such as a wired or wireless public communication network, a dedicated communication network, a mobile telephone network, the Internet, an intranet, a LAN (Local Area Network), a WAN (Wide Area Network), a satellite communication network, or an appropriate combination thereof.

Communication between information terminals 12a and 12b and the information provider server 11 may also be achieved using a CS broadcast or a BS broadcast via a broadcast satellite, a terrestrial digital broadcast, or a multiplexed FM broadcast. Communication may also be achieved using a light beacon or a radio beacon disposed along a road side.

In the illustrated embodiment, the information display system is composed of the information provider server 11 and the information terminals 12a and 12b. It is assumed that users are registered in advance and registered IDs are given to the respective users. The information terminals 12a and 12b are also registered.

Each of the information terminals 12a and 12b used in this embodiment has browser software that allows a user to access Web sites via the Internet and browse various kinds of information available on home pages and/or Web pages. It is also possible that each information terminal gains access to a Web site, such as a ASP (Application Service Provider), to request it to search for a Web page on which desired information is described. It may also be possible to arrange for various kinds of application programs to be downloaded from Web sites, such as an ASP.

In the embodiment, information provider server 11 includes the following parts or components: an information providing unit 13 for providing the information terminal 12a or 12b with information relating to a starting place or a destination informed by the information terminal 12a or 12b, information indicating a route to the destination, and other various kinds of information; a transmitter/receiver unit 14 for transmitting/receiving information to/from the information terminals 12a and 12b; a terminal information storage unit 15 for storing information associated with each of the information terminals 12a and 12b; and a terminal identification unit 16 for identifying the information terminals 12a and 12b on the basis of their registered IDs.

The information providing unit 13 includes a map database 17 serving as a map information storage unit, a POI (Point of Interest) database 18, a road database 19, a traffic information database 20 serving as a road traffic information storage unit, and a PIM (Personal Information Manage) database 21 serving as a schedule information storage unit.

The map database 17 stores map information including nodes, links, coordinates, and facility names, on the basis of which a map is drawn. The POI database 18 stores facility data, town page data, and event data. Herein, the facility data refers to data necessary in searching for places, such as a starting place, a destination, or a passing place. Note that in the present description, the term “facility” is used to generically describe any place to visit or pass including buildings, stores, and the like. The road database 19 stores data for use in searching for the route, such as data indicating costs of searching routes, data indicating the types of roads, etc.

By way of example, the traffic information database 20, when linked to a vehicle information communications system called VICS(R), stores traffic congestion information produced on the basis of information collected from traffic control systems operated by the police, highway authorities, or other entities which collect traffic information, and also stores traffic information such as traffic control information. Preferably, the traffic information database 20 also stores the following information: event schedule information indicating places and dates/times of events, such as a festival, a parade, a fireworks display, and the like; statistically predicted traffic congestion information indicating that traffic congestion occurs on a particular road near a particular station or a particular commercial place in a particular time zone every day except for weekends, or information indicating that traffic congestion occurs on a particular road near a particular bathing beach in a summer period; and weather information, such as weather forecast information provided by a meteorological agency.

The PIM database 21 stores personal files corresponding to different users, wherein personal information associated with each user, such as a schedule, a calendar, an address table, a telephone number table, a registered place table, and/or a memo pad, is stored in a corresponding personal file. More specifically, each personal file includes a schedule file in which a schedule is stored, a calendar file in which a calendar is stored, an address table file in which an address table is stored, a telephone number table file in which a telephone number table is stored, a registered place table file in which a registered place table is stored, and a memo pad file in which a memo pad is stored, wherein each personal file is constructed in accordance with the attribute of the individual user. Although in the present embodiment the personal files are constructed for every registered user, personal files may be constructed for every information terminal. If a plurality of registered IDs are allocated to a user, personal files may be constructed for every registered ID.

An internal storage medium of the information provider server 11 or, alternatively, an external storage medium may be used as storage means for storing the map database 17, the POI database 18, the road database 19, the traffic information database 20, and the PIM database 21. The internal storage medium or the external medium may be any type of storage medium, such as a magnetic tape, a magnetic disk, a magnetic drum, a CD-ROM, a MD, a DVD-ROM, an optical disk, a MO disk, a IC card, an optical card, or a memory card.

The information providing unit 13 includes a map generator 22 for generating a map on the basis of the map information, a POI search unit 23 for searching for place information, such as coordinate information, the name, or the address of a specified place such as a facility or a destination based on information stored in the POI database 18, and a route searching unit 24 for searching for a route from a current position to a destination based on information stored in databases, such as the road database 19 and/or traffic information database 20.

The information providing unit 13 includes a PIM processor 25 and a transmission information generator 26, wherein the PIM processor 25 produces and updates schedules, calendars, address tables, telephone number tables, registered place tables, and memo pads of individual users based on information received from the information terminals 12a and 12b. The PIM processor 25 also extracts necessary information from the schedules, the calendars, the address tables, the telephone number tables, the registered place tables, and the memo pads. In the meantime, the transmission information generator 26 generates and edits information to be transmitted to the information terminal 12a or 12b, in response to a request from these information terminal 12a or 12b.

The information providing unit 13 includes a destination setting unit, an arrival time predictor and a comparator, and stores various programs including a PIM program and a route searching program. The PIM program is a program for managing schedule, a calendar, an address table, a telephone number table, a registered place table, and a memo pad of a user, and may be similar to a program widely used in mobile information terminals, PDA devices or personal computers.

If position information, such as a destination, a passing point, or a registered place has been registered in the schedule, the calendar, the address table, the telephone number table, the registered place table, or the memo pad, the destination setting unit sets a destination based on the position information. The arrival time predictor determines a predicted the time of arrival at the destination, based on the information associated with a route retrieved by the route searching unit 24, for example, based on the sum of times needed to travel respective sections in the route. The arrival time predictor may update the predicted arrival time at predetermined intervals of time. The update may be performed by recalculating the predicted arrival time, taking into account the latest traffic congestion information and/or traffic control information stored in the traffic information database 20. The comparator compares the predicted arrival time with a desired arrival time.

Each of the information terminals 12a and 12b includes a transmitter/receiver unit and a display controller. The transmitter/receiver unit transmits or receives information, such as information included in the schedule, the calendar, the address table, the telephone number table, the registered place table, and the memo pad, to or from the information provider server 11. Upon receipt of a calendar and a map from the information provider server 11, the information terminal 12a or 12b causes the calendar and the map to be displayed on the display, and further causes the current position of the information terminal 12a or 12b, the destination, and various nearby facilities to be displayed on the map. Preferably, also displayed are other various kinds of information, such as the desired arrival time, the predicted arrival time, the name and the address of the destination, the facility data, town page data, event data, traffic information, information about events to be held, statistically predicted traffic congestion information, and/or weather information.

In the illustrated embodiment, the information provider server 11 has databases, such as the map database 17 and the PIM database 21, and also has means, such as the route searching unit 24 and the PIM processor 25. In response to a request from the information terminal 12a or 12b, the information provider server 11 searches for a route and produces, updates, and edits the schedule, the calendar, the address table, the telephone number table, the registered place table, and the memo pad, and transmits the results to the information terminal 12a or 12b. Consequently, the information terminals 12a, 12b can be implemented to have a simple configuration. This allows reductions in the size and the weight of the information terminals 12a and 12b, contributing to reduction in the production cost.

The information terminals 12a and 12b may have a database, such as the map database 17, and may further have means, such as the route searching unit 24, so that the information terminals 12a and 12b can perform searching for routes. In this case, the information provider server 11 can be constructed in a simpler form and a reduction in the operation cost is achieved.

It is also to be understood that the POI database 18, the road database 19, the traffic information database 20, the PIM database 21, the POI search unit 23, the PIM processor 25, the destination setting unit, the arrival time predictor, and the comparator are incorporated in the information terminals 12a and 12, instead of being mounted in the information provider server 11.

In the information terminals 12a and 12b, the display and/or the audio output device functions as a route guiding unit for performing guiding in terms of the route obtained through the search. The PIM processor 25 functions as an information extractor for extracting position identification information from a facility information screen, such as a Web page screen, and also functions as a facility information registration unit for registering facility information including information indicating the positions of facilities. The PIM database 21 functions as a facility information storage unit for storing registered facility information. The facility information refers to various kinds of information relating to facilities, and may include schedule information associated with scheduled dates/times.

A description will now be given of the information display system having the configuration heretofore explained.

It is assumed in this example that the information provider server 11 has databases, such as the map database 17 and the POI database 18, the traffic information database 20, and the PIM database 21, and also provided with means, such as the route searching unit 24 and the PIM processor 25. It is also assumed that the information provider server 11 searches for a route in response to a request from the information terminal 12a and produces, updates, and edits the schedule, the calendar, the address table, the telephone number table, the registered place table, and the memo pad, and transmits the results to the information terminal 12a. An assumption is also made that the information terminal 12a is a navigation apparatus mounted on a vehicle.

The information terminal 12b may be a mobile telephone or a PHS telephone, from which the user may transmit a request for searching a route or a request for producing, updating, or editing a schedule, a calendar, an address table, a telephone number table, a registered place table, or a memo, to the information provider server 11. The information provider server 11 then transmits the result to the information terminal 12a which is the navigation apparatus mounted on a vehicle. In this case, the same user operates both the information terminals 12a and 12b.

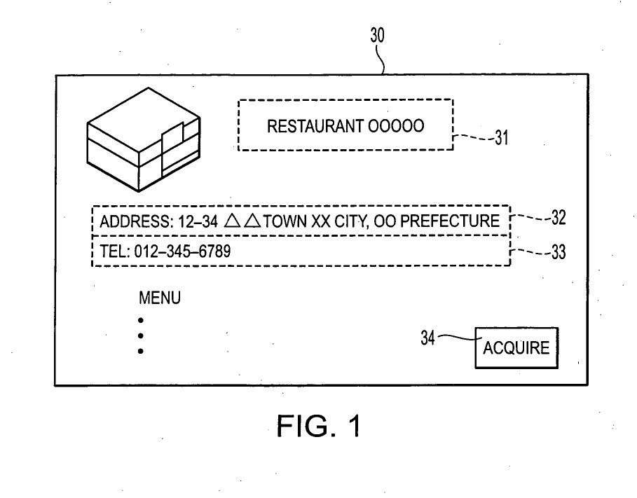

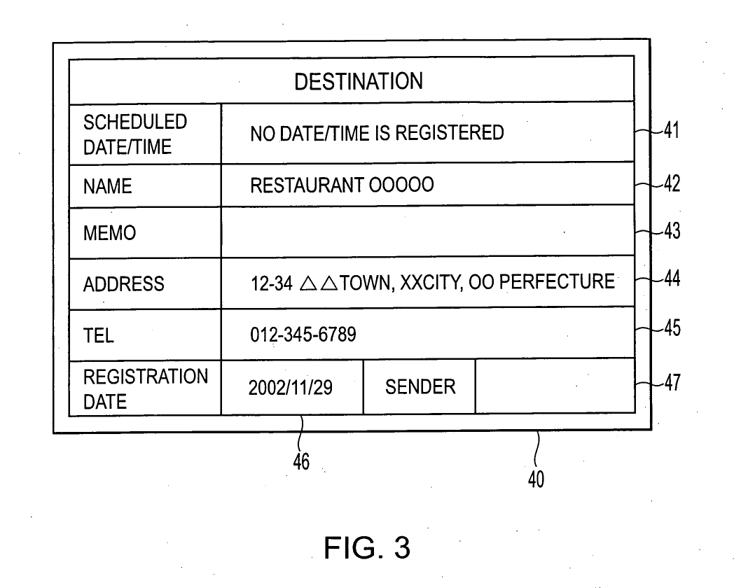

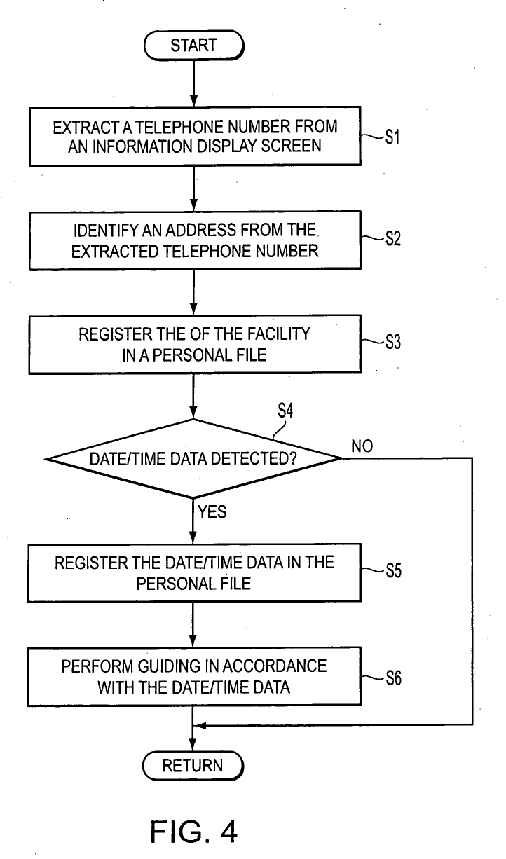

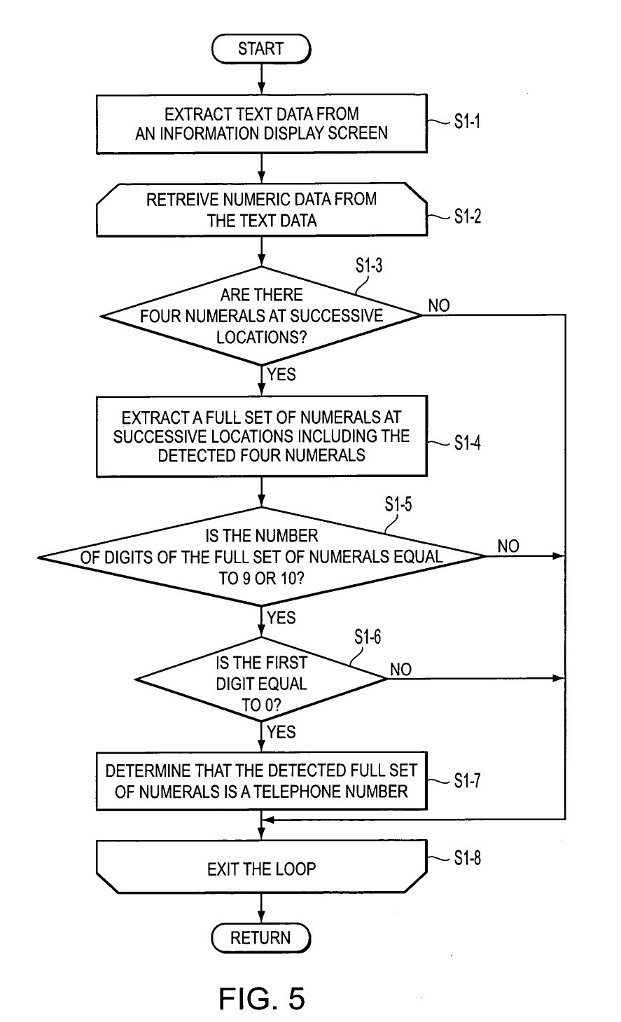

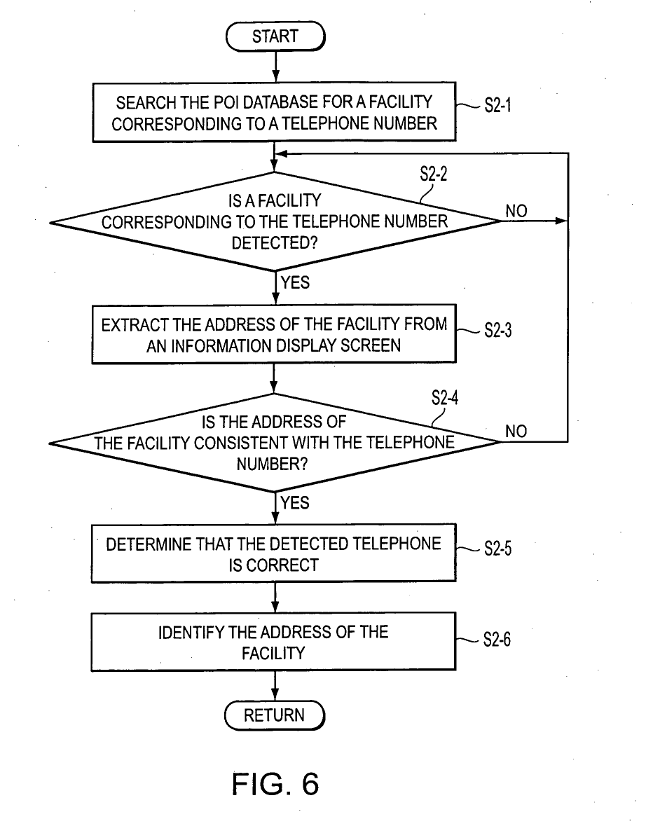

FIG. 1 shows a first example of the contents of the display on the display screen of an information terminal according to the first embodiment of the present invention. FIG. 3 shows a second example of the contents displayed on the display screen of the information terminal according to the first embodiment of the present invention. FIG. 4 is a flow chart showing a process of displaying information in accordance with the first embodiment of the present invention. FIG. 5 is a flow chart showing a process of extracting a telephone number in accordance with the first embodiment of the present invention. FIG. 6 is a flow chart showing a process of registering facility information in accordance with the first embodiment of the present invention.

First, a user operates the information terminal 12a to gain, via the network 27, access to a Web site, popularly called a search site, that provides a service of searching for a Web page on which desired information is provided. Via the search site, the user searches for a Web page on which desired information, such as information about a job, learning, a hobby, a sport, a restaurant, sightseeing, shopping, or chores, is available. Herein, by way of example, it is assumed that a Web page, including information about a restaurant that satisfies a particular requirement, is searched for as a facility to be registered.

In this case, the user activates the browser software on the information terminal 12a to make access to the Web site. As a result, a search dialog box is displayed on the display of the information terminal 12a. As the user inputs requirements associated with the type of food, a price, etc., searching is performed and a list of URLs (Uniform Resource Locators) of Web pages including information about restaurants satisfying the above requirements or a list of restaurant names linked to Web pages is displayed. The links are described in the form of text data enclosed between anchor tags in HTML (Hyper Text Markup Language). Clicking on a character string between the anchor tags allows a jump to a file or a character string designated by the anchor tags.

The user clicks on a desired URL or a restaurant name with a link displayed on the display of the information terminal 12a. Herein, let us assume that a particular restaurant name is clicked. As a result, a Web page including information about the restaurant, such as a home page of the restaurant, is accessed and displayed as a facility information screen. For example, as shown in FIG. 1, an information display screen 30 is displayed on the display of the information terminal 12a.

The information display screen 30 includes a restaurant name 31 as the facility name, the address of the restaurant 32 as the address of the facility, and a telephone number 33 as the telephone number of the facility. In the illustrated exemplary embodiment, the facility data or the town page date stored in the POI database 18 of the information provider server 11 includes a table representing the correspondence between addresses 32 of facilities and telephone numbers 33. In a case in which the telephone number 33 is available from a telephone directory or the telephone number 33 has already been registered by the user, the address 32 of the facility corresponding to the telephone number can be detected by performing a search through the correspondence table based on the telephone number 33. The map coordinates corresponding to the address 32 can be identified based on the map information stored in the map information database 17 stored in the information provider server 11. Thus, in this embodiment, the address 32 and the telephone number 33 of the facility specified as the destination serve as position identification information identifying the position of the facility. Although in the example shown in FIG. 1 the information display screen 30 includes one address 32 and one telephone number 33, the information display screen 30 may contain a plurality of addresses 32 and/or a plurality of telephone numbers 33.

The information display screen 30 also includes an acquire button 34 serving as an acquisition command issuing means for issuing a command to acquire the position identification information concerning the position of the restaurant. It is to be noted that the acquire button 34 is not necessarily needed to be included in the information display screen 30. When the acquire button 34 is omitted, the input device of the information terminal 12a may serve as the acquisition command issuing means. In such a case, the user can issue a command to acquire the acquire the position identification information concerning the position of the restaurant by operating the input device of the information terminal 12a, such as a keyboard, a joy stick, arrow keys, push buttons, or a remote control unit.

As the user issues the command to acquire the position identification information of the position of the restaurant by clicking or pressing the acquire button 34, the command to acquire the position identification information concerning the position of the restaurant is transmitted together with the information display screen 30 to the information provider server 11. The PIM processor 25 of the information provider server 11 has a function to extract a word or phrase, such as a keyword from a sentence written in natural language. The PIM processor 25 therefore extracts the telephone number 33 from the data of the information display screen 30.

The PIM processor 25 also has a function to verify the consistency between the telephone number 33 and the address 32, when setting the specified point. More specifically, the PIM processor 25 first extracts text data from the data of the information display screen 30 and searches for numeric data from the extracted text data. The PIM processor 25 then determines whether numeric data, including four-figure numerals, exists. In many cases, numeric data appearing in usual sentences or text data includes three or less digits or figures. Therefore, when numerical data including four numerals at successive positions is detected, the detected numeric data is highly likely to be part of the telephone number 33.

Thereafter, the PIM processor 25 extracts the four-figure numeric data together with numeric data which precedes the four-figure numeric data in terms of the position on the text, namely, numeric data which includes the detected four numerals and numeric data preceding the detected four numerals. The PIM processor 25 then determines whether the number of figures of the detected full numeric data is equal to 9 or 10. In Japan, 9 or 10-figure numerals are used as telephone numbers. Therefore, if the number of figures of the detected full numeric data is neither 9 nor 10, it can be concluded that the detected full numeric data is not a telephone number 33.

The PIM processor 25 then determines whether the first figure of the 9 or 10-figure numeric data is 0. In Japan, the area code of any telephone number starts with 0. Therefore, if the first figure of the numeric data is not 0, the numeric data cannot be a telephone number 33. If the first digit is equal to 0, the PIM processor 25 determines that the numeric data is a telephone number 33. The PIM processor 25 performs the above-described process repeatedly for all numeric data extracted from the text data thereby determining whether each numeric data is a telephone number 33. The telephone numbers 33 are thus extracted from the information display screen 30. It is to be understood that when the information display screen 30 also includes telephone numbers other than the telephone number 33 of the restaurant, that is, when the information display screen 30 contains a plurality of telephone numbers, all such telephone numbers are extracted.

The PIM processor 25 then identifies the position of the restaurant specified as the facility based on the extracted telephone numbers 33. More specifically, the PIM processor 25 first searches for facilities corresponding to all respective telephone numbers extracted from the information display screen 30 based on the table indicating the correspondence between the addresses 32 of facilities and the telephone numbers 33 stored in the POI database 18. The PIM processor 25 then determines whether a facility of the address corresponding to each telephone number exists. In the above determination process, if no facility corresponding to a telephone number is detected in the correspondence table, the PIM processor 25 determines whether a facility exists corresponding to a next telephone number.

If a facility corresponding to a telephone number is detected, the PIM processor 25 extracts the address 32 of the restaurant from the text data extracted from the information display screen 30. In general, it is difficult to correctly extract an address from text data. In this embodiment, in order to overcome the difficultly, only prefecture names are extracted but following region names such as city names, town names, street numbers, etc. are not extracted. As for the names of prefectures in Japan, prefecture names can be correctly extracted by extracting a Japanese character that appears at the end of each prefecture name (because each prefecture name ends with one of four Japanese characters pronounced as “to”, “dou”, “fu”, and “ken”). The PIM processor 25 determines whether the extracted address 32 of the restaurant corresponds to the extracted telephone number 33, by comparing an extracted prefecture name with the prefecture name corresponding to the area code of the extracted telephone number. If the address 32 does not correspond to the telephone number, the PIM processor 25 performs the above-described examination on a facility corresponding to a next telephone number.

If it is determined that the address 32 corresponds to the telephone number 33, the PIM processor 25 determines that the telephone number 33 has been correctly detected, and the PIM processor 25 identifies the address 32 of the restaurant, that is, the position of the facility. The PIM processor 25 then registers the address 32 of the restaurant as the identified position of the facility in the use's personal file stored in the PIM database 21. In the registration, the address 32 serving as position identification information is registered as a specified destination in a destination field in the user's schedule. Preferably, the name of the specified destination is also registered in the schedule. The registration of the name may be performed by the user by inputting the name into the information terminal 12a, or the name 31 of the restaurant extracted by the PIM processor 25 from the text data may be automatically registered as the name of the specified point.

The user may also register date/time data related to the destination, as one of scheduled items. More specifically, the date and time when the user will make a stop at the restaurant registered as the destination may be registered as date/time data in the schedule. In the registration, the date/time data may include all values indicating a year, a month, a day, an hour, and a minute, or may omit the hour value and the minute value. When the user registers the date/time data, the user inputs date/time data by operating the information terminal 12a and further inputs a command to register the date/time and sends the registration command and the date/time data to the information provider server 11. In a case in which the text data extracted from the information display screen 30 includes characters indicating a date and/or a time, the PIM processor 25 may extract the characters indicating the date and/or the time and register the date/time data in the schedule.

After completion of registering the address 32 of the restaurant, the PIM processor 25 determines whether date/time data to be registered has been received. If date/time data has been received, the PIM processor 25 registers the date/time data as scheduled date/time in connection with the address 32 of the restaurant in the personal file corresponding to the user in the PIM database 21. Thus, the schedule information indicating that the user is scheduled to make a stop at the restaurant on the scheduled date/time is registered as the schedule of the user.

The user may check the schedule at an arbitrary desired time. To check the schedule, the user accesses the information provider server 11 by operating the information terminal 12a and searches for the schedule registered in the personal file corresponding to the user thereby acquiring the schedule. As a result, schedule information 40 is displayed on the display of the information terminal 12a. FIG. 3 shows a specific example of the schedule information 40. When searching for the schedule, the user inputs schedule items such as the date/time, the name of the destination, the address 32 of the facility specified as the destination, and/or the telephone number 33 of the facility.

As shown in FIG. 3, the displayed schedule information 40 includes a scheduled date/time field 41 in which the scheduled date/time is described as one of schedule items, a name field 42 in which the name of the place or the facility specified as the destination is described as one of schedule items, a memo field 43 in which a memo associated with the schedule is described as one of schedule items, an address field 44 in which the address 32 of the point or the facility is described, a telephone number field 45 in which the telephone number 33 of the facility is described, a registered date field 46 in which the date registered in the schedule is described, and a sender field 47 in which a sender name is described when the schedule items have been sent from a sender other than the user. The schedule information 40 makes it possible for the user to easily check and recognize the details of the registered schedule. In the example shown in FIG. 3, no date/time data is registered in the personal file corresponding to the user, and thus the scheduled date/time field 41 remains empty.

In a case in which date/time data is registered in the personal file corresponding to the user, when the scheduled date/time described in the schedule is reached, the information providing unit 13 of the information provider server 11 searches for a route to the restaurant specified as the destination, and generates route information indicating the route to the restaurant and also generates route guide information necessary for performing guiding along the route. More specifically, the route searching unit 24 accesses the map database 17, the POI database 18, the road database 19, and the traffic information database 20, and searches for the route to the restaurant, thereby generating the route information and the route guide information. The generated route information and route guide information are transmitted from the information provider server 11 to the information terminal 12a serving as the navigation apparatus mounted on the vehicle. In accordance with the received route information and route guide information, the information terminal 12a displays the route to the restaurant on the display and starts to guide the user along the route. . This allows the user to easily get to the restaurant simply by driving along the guided route.

Searching for the route to the restaurant and the generation of the route information and the route guide information, as well as the transmittance of the result to the information terminal 12a, may be performed before the scheduled date/time is reached. In this case, the received route information and route guide information are stored in the storage device of the information terminal 12a, and the route to the restaurant is displayed on the display according to the route information when the scheduled date/time is reached, and guiding of the route is started.

In the exemplary embodiment heretofore described, the PIM processor 25 of the information provider server 11 extracts the address 32 and the telephone number 33 of the facility from the text data included in the information display screen 30, and registers the extracted address 32 and the telephone number 33 as schedule items in the schedule of the user. Furthermore, the route searching unit 24 of the information provider server 11 searches for the route to the restaurant and generates the route information and the route guide information. Alternatively, the information terminal 12a or the information terminal 12b may incorporate the PIM processor 25 and the route searching unit 24, so that the information terminal 12a or the information terminal 12b extracts the address 32 and the telephone number 33 of the facility from the text data included in the information display screen 30 and generates the route information and the route guide information.

The process is described in further detail below with reference to a flow chart (FIG. 4). First, a flow of a process of displaying information will be described.

Step S1. A telephone number 33 is extracted from the information display screen 30.

Step S2. The address 32 of a facility is identified from the extracted telephone number 33.

Step S3. The identified address 32 of the facility is registered in a personal file.

Step S4. It is determined whether or not there is date/time data. If there is date/time data, the process proceeds to step S5, otherwise the process is ended.

Step S5. The date/time data is registered in the personal file.

Step S6. A route is searched for based on the date/time data, and guiding is started. After completion of guiding, the process is ended.

A flow of a process of extracting a telephone number will be described below with reference to FIG. 5.

Step S1-1. Text data is extracted from the information display screen 30.

Step S1-2. A processing loop is started to extract numeric data from the extracted text data.

Step S1-3. It is determined whether or not four-figure numeric data exists. If exists, the process proceeds to step S1-4, otherwise the process jumps to step S1-8.

Step S1-4. A full set of numeric data including the four-figure numeric data and preceding numeric data is extracted.

Step S1-5. It is determined whether the extracted full set of numeric data includes nine or ten figures. If the extracted full set of numeric data includes nine or ten figures, the process proceeds to step S1-6, otherwise the process jumps to step S1-8.

Step S1-6. It is determined whether the first figure is 0. If so, the process proceeds to step S1-7. However, if the first digit is not 0, the process jumps to step S1-8.

Step S1-7. It is determined that the extracted full set of numerals is a phone number 33.

Step S1-8. The process exits the loop.

A flow of a process of registering facility information will now be described with reference to FIG. 6.

Step S2-1. A search is performed through the POI database 18 to find a facility corresponding to the telephone number 33.

Step S2-2. It is determined whether a facility corresponding to each telephone number 33 is detected. If a facility is detected, the process proceeds to step S2-3. However, if no facility is detected, it is determined whether a facility corresponding to a next telephone number is detected.

Step S2-3. The address 32 of the facility is extracted from the information display screen 30.

Step S2-4. It is determined whether the address 32 of the facility is consistent with the telephone number 33. If they are consistent with each other, the process proceeds to step S2-5, otherwise the process returns to step S2-2.

Step S2-5. It is determined that the telephone number 33 has been correctly acquired.

Step S2-6. The address 32 of the facility is identified.

In the illustrated exemplary embodiment, as described above, the user causes the display of the information terminal 12a to display a Web page carrying information, such as information about a job, learning, a hobby, a sport, a restaurant, sightseeing, shopping, or chores. As the user operates the acquisition command issuing means to acquire the address 32 or the telephone number 33 of a facility shown on the Web page as position identification information, the position identification information is automatically registered in the schedule of the user as the position identification information identifying the specified point.

Therefore, the user when setting the destination is not required to input the address 32 or the telephone number 33 of the facility into the information terminal 12a serving as the navigation apparatus mounted on the vehicle. Thus, the user can easily set the destination in a short time without being bothered by laborious work. Furthermore, there is no risk of inputting a wrong address 32 or telephone number 33 of the facility.

A second exemplary embodiment of the present invention will now be described. Description of the configuration and operation that are the same or similar to those of the first embodiment will be omitted.

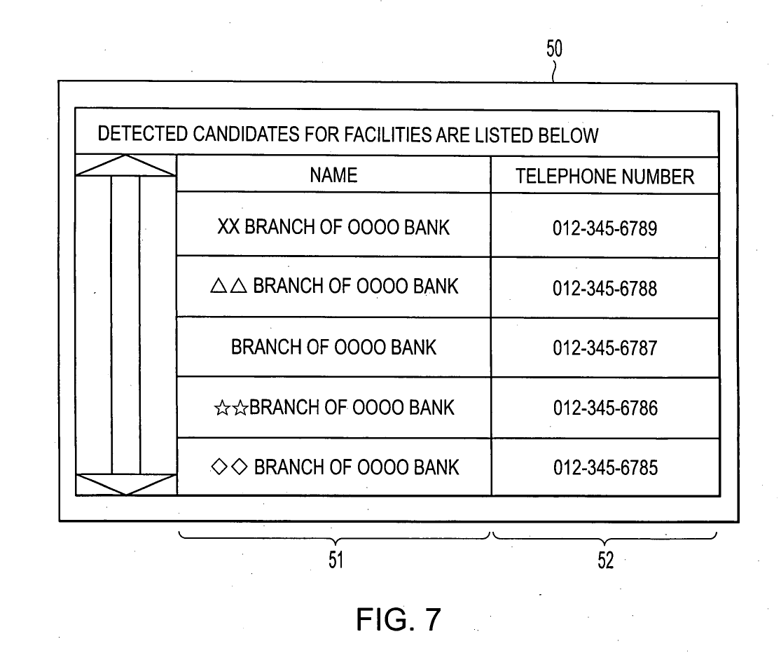

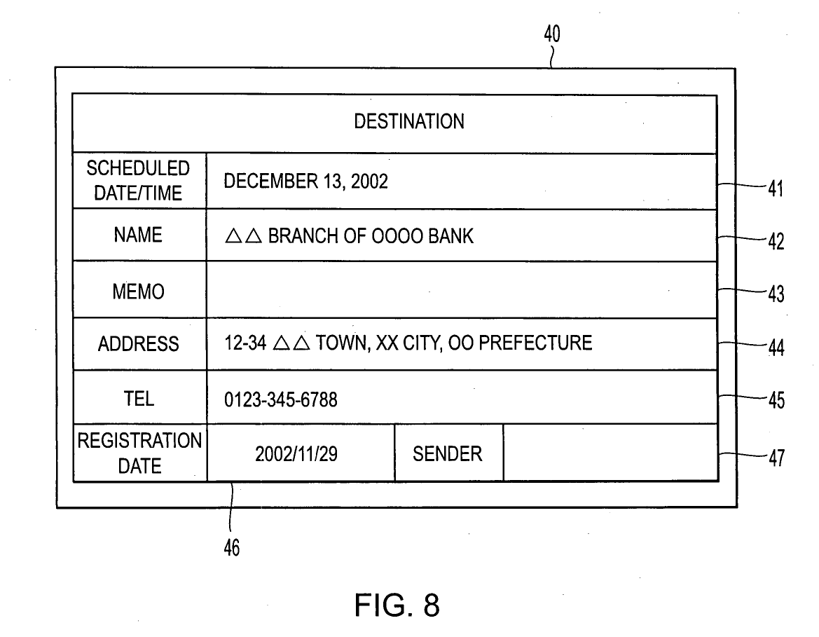

FIG. 7 is a diagram showing a first example of the display screen of an information terminal according to the second exemplary embodiment of the present invention, and FIG. 8 is a diagram showing a second example of the display screen of the information terminal according to the second embodiment of the present invention.

In this exemplary embodiment, it is assumed that the information display screen 30 includes a plurality of telephone numbers 33, and that there are facilities corresponding to the respective telephone numbers 33. In this case, the PIM processor 25 identifies the plurality of facilities and generates a list of candidates for facilities 50, such as that shown in FIG. 7. The generated list of candidates for facilities 50 is transmitted from the information provider server 11 to the information terminal 12a and displayed on the display of the information terminal 12a. As shown in FIG. 7, the list of candidates for facilities 50 includes facility name fields 51 in which the names of facilities are described and telephone number fields 52 in which the telephone numbers 33 of the respective facilities are described. In the example shown in FIG. 7, facilities are branches of a bank.

The user operates the information terminal 12a to select a facility, for example, ΔΔ Branch of ◯◯◯◯ Bank, described in a facility name field 51 in the list of candidates for facilities 50, and sends data associated with the selected facility to the information provider server 11. In accordance with the data associated with the selected facility received from the information terminal 12a, the PIM processor 25 registers the name, the address 32, and the telephone number 33 of the ΔΔ Branch of ◯◯◯◯ Bank selected as the facility. In a case in which the user inputs date/time data by operating the information terminal 12a and further inputs a command to register the date/time data, the registration command is sent together with the date/time data to the information provider server 11, and the date/time data is registered as a scheduled date/time. In a case in which the text data extracted from the information display screen 30 includes characters indicating a date and/or a time, the PIM processor 25 may extract the characters indicating the date and/or the time and may register the date/time data in the schedule.

In this case, if the user accesses the information provider server 11 by operating the information terminal 12a and searches for a schedule registered in the personal file corresponding to the user thereby acquiring the schedule, schedule information 40, such as that shown in FIG. 8, is displayed on the display of the information terminal 12a. In the present example, because date/time data is registered in the personal file corresponding to the user, the scheduled date/time is displayed in the scheduled date/time field 41. In the specific example shown in FIG. 8, “Dec. 13, 2002” is displayed as the scheduled date/time in the scheduled date/time field 41.

Thus, when the scheduled date/time is reached, that is, on Dec. 13, 2002, the information providing unit 13 of the information provider server 11 searches for a route to the ΔΔ Branch of ◯◯◯◯ Bank registered as the specified point and generates route information and route guide information necessary in guiding of the route. More specifically, the route searching unit 24 accesses the map database 17 and the POI database 18, the road database 19, and the traffic information database 20, and the route searching unit 24 searches for the route to the ΔΔ Branch of ◯◯◯◯ Bank and generates the route information and the route guide information. The generated route information and route guide information are transmitted from the information provider server 11 to the information terminal 12a serving as the navigation apparatus mounted on the vehicle.

Searching for the route to the ΔΔ Branch of ◯◯◯◯ Bank and the generation of the route information and the route guide information may be performed before the scheduled date/time is reached, and the resultant generated information may be transmitted to the information terminal 12a. In this case, the received route information and route guide information are stored in the storage device of the information terminal 12a, and the route to the ΔΔ Branch of ◯◯◯◯ Bank is displayed on the display according to the route information when the scheduled date/time is reached, and guiding of the route is started.

In accordance with the received route information and route guide information, the information terminal 12a displays the route to the ΔΔ Branch of ◯◯◯◯ Bank on the display and starts to guide the user along the route. This allows the user to easily get to the ΔΔ Branch of ◯◯◯◯ Bank simply by driving along the guided route.

In this embodiment, as described above, when a plurality of addresses 32 or telephone numbers 33 of facilities are described as position identification information on a Web page, a list of candidates for facilities 50 is generated and displayed. If the user selects a desired one of facilities included in the list of candidates for facilities 50, the position identification information of the selected facility is automatically registered as the position identification information of the specified point in the schedule of the user. Thus, even when a plurality of addresses 32 or telephone numbers 33 of facilities are described as position identification information on a Web page, the user can easily set the destination in a short time without being annoyed by a troublesome operation.

In a case in which date/time data indicating a scheduled date/time has been registered, when the scheduled date/time is reached, guiding of the route to the specified point is automatically started, and thus the user can easily get to the specified point simply by driving along the guided route.

A third exemplary embodiment of the present invention is described below. Description of the configuration and operation which are the same or similar to those of the first and second embodiments is omitted.

In this embodiment, on a day before a registered scheduled date/time, a user is notified that the scheduled date/time is coming soon. Herein, it is assumed that date/time data indicating the scheduled date/time has already been registered in a manner similar to the second embodiment.

In order that a notification of a registered schedule is given before a scheduled date/time, it is required to make a setting associated with the notification. The timing of notifying of the schedule is set in advance by the user to a proper date/time before the scheduled date/time. In this embodiment, it is assumed that notification of the schedule is performed when the power of the information terminal 12a is turned on, on the day before the scheduled date/time.

Thus, on the day before the scheduled date/time, if the user operates the information terminal 12a to turn on the power of the information terminal 12a, information indicating that the scheduled date/time will be reached on the next day is displayed on the display of the information terminal 12a. In a case in which the information terminal 12a is a navigation apparatus mounted on a vehicle, the power of the information terminal 12a is generally turned on automatically when the engine of the vehicle is started, and thus the user does not have to operate the information terminal 12a to turn on the power thereof.

Thereafter, if the user operates the information terminal 12a, the schedule information 40 is displayed on the display to inform the user in advance of the schedule. This ensures that the user is informed of the details of the registered schedule in advance.

It is desirable that the user can set the timing of notifying the schedule to an arbitrary desired date/time. The timing may be set in units of days, for example, to one or two days before the scheduled date/time or in units of particular time periods, such as a period from 18:00 to 22:00 on a day before the scheduled date/time or a morning period of the scheduled date/time. The timing may also be specified roughly. For example, the notification of the schedule may be set to be given in the early morning, in the morning, in the daytime, at night, or at midnight.

If the information terminal 12a includes a current position detector as is the case of a navigation apparatus or a mobile telephone, a condition relating to a position, e.g., the user's home or office, may be added to the timing condition. For example, the notification may be specified to be given when the user arrives at home on a day before the scheduled date/time, or when the user arrives at his/her office on the same day as the scheduled date/time. In the case in which the notification of the schedule is specified to be given when the user arrives at home on a day before the scheduled date/time, if the information terminal 12a enters a pre-registered region, for example, a range of a radius of 500 m from the user's house, on the day before the scheduled date/time, the notification of the registered schedule is given.

Likewise, in the case in which the notification of the schedule is specified to be given when the user arrives at the user's office on the same day as the scheduled date/time, if the information terminal 12a enters a pre-registered region, for example, a range of a radius of 500 m centered at the user's office on the same day as the scheduled date/time, the notification of the registered schedule is given. Only a position may be specified as a condition of notifying the schedule. For example, if a station near the user's house, a particular department store, or a park is specified as the position, then the notification of the schedule is given whenever the information terminal 12a enters a predetermined region around the specified position.

The notification of the schedule may be given by displaying the schedule on the display or by generating a voice or a sound, such as a music sound or a chime sound. For example, in a case in which the notification of the schedule is specified to be given when the user arrives home in the evening on a day before the scheduled date/time, a female voice saying “a meeting is to be held at ◯◯ Company at ◯ minutes past ◯◯ o'clock” may be generated when the scheduled notification is satisfied. In an exemplary embodiment of the invention, the user can select a male voice or a female voice. Alternatively, a voice of a pre-registered person, such as a family member, a friend, an actor, an actress, or a singer may be used.

The manner of notifying the schedule may be automatically switched, for example, between displaying the schedule on the display and generating a voice/sound depending on the time zone. The content to be notified may also be selected depending on the time zone. For example, in a case the timing is roughly set to a time zone, such as early morning, morning, daytime, night, or midnight, the notification of the schedule of the current day may be given by a sound in the early morning and the notification of the schedule of the next day may be displayed on the display. In the morning or the daytime, the notification of the schedule of the current day may be given by means of both a voice/sound and displaying, and the notification of the schedule of the next day may be given only by means of displaying. At night or midnight, both the notification of the schedule of the current day and the notification of the schedule of the next day may be given by means of displaying.

Notifying of the schedule before the scheduled date/time may also be performed by transmitting notification information to another information terminal, such as the information terminal 12b. In a case in which the information terminal 12b is a device that is always brought by the user, such as a mobile telephone, a PHS telephone, a portable information terminal, or a PDA device, or in a case in which the information terminal 12b is a device that is always operated by the user, such as a personal computer installed in user's home or office, notifying of the schedule may be performed by displaying the schedule on the display of the information terminal 12b or by means of a speaker.

The arrangement may be such that a schedule sent from a person other than the user is received and registered so that the schedule is set to be notified before the scheduled date/time. In this case, the person other than the user must be registered in advance in the information display system and must have a registered ID. In many cases, the person other than the user is a friend, an acquaintance, or a family member of the user. It is desirable that the person other than the user be registered as a friend in the personal file of the user in the PIM database 21, although the registration is not necessarily required.

More specifically, the person other than the user sends the schedule information addressed to the user from his/her information terminal to the information provider server 11 via the network 27. Herein, the schedule information may include, for example, a schedule of a business meeting, a banquet, a party, a date, or meeting someone, and may include information indicating the date/time and the place. In a case in which a sender name is described in the sender field, the schedule is regarded as a friend link and stored in a friend link file. Herein, the friend link refers to personal information transmitted from another person other then the user to the user. Friend link files for storing friend links are formed in connection with the respective personal files in the PIM database 21.

The friend link file makes it possible for the user not only to manage the schedule of the user but also to know the schedule of another person, such as a friend, an acquaintance, or a family member of the user, sent from them. In a case in which the schedule received from another person other than the user includes a schedule of a business meeting, a banquet, a party, a date, or meeting someone, in which the user himself/herself is to participate, for example, the received schedule information is incorporated into the personal file of the user.

That is, the schedule information received from another person such as a friend, an acquaintance, or a family member of the user can be incorporated into the personal file of the user, and can be set to be notified before the scheduled date/time. This makes it possible for the user to directly use, as the schedule information associated with the user himself/herself, the schedule information received from another person without having to perform a troublesome job to revise the schedule.

In this embodiment, as described above, notifying of a registered schedule is performed before a scheduled date/time by means of displaying or a voice/sound thereby ensuring that the user checks and recognizes the schedule before the scheduled date/time.

The condition of notifying the schedule can be set properly by the user so that the schedule is notified with the best timing. Furthermore, the user can select the best manner of notifying the schedule. That is, the schedule can be set to be notified before the scheduled date/time by means of a desired display or a voice/sound selected by the user.

Thus, this embodiment of the invention makes it possible for the user to easily and surely check and recognize the schedule before the scheduled date/time.

A fourth exemplary embodiment of the present invention is described below. Description of components and operations similar to those of the first to third embodiments is omitted.

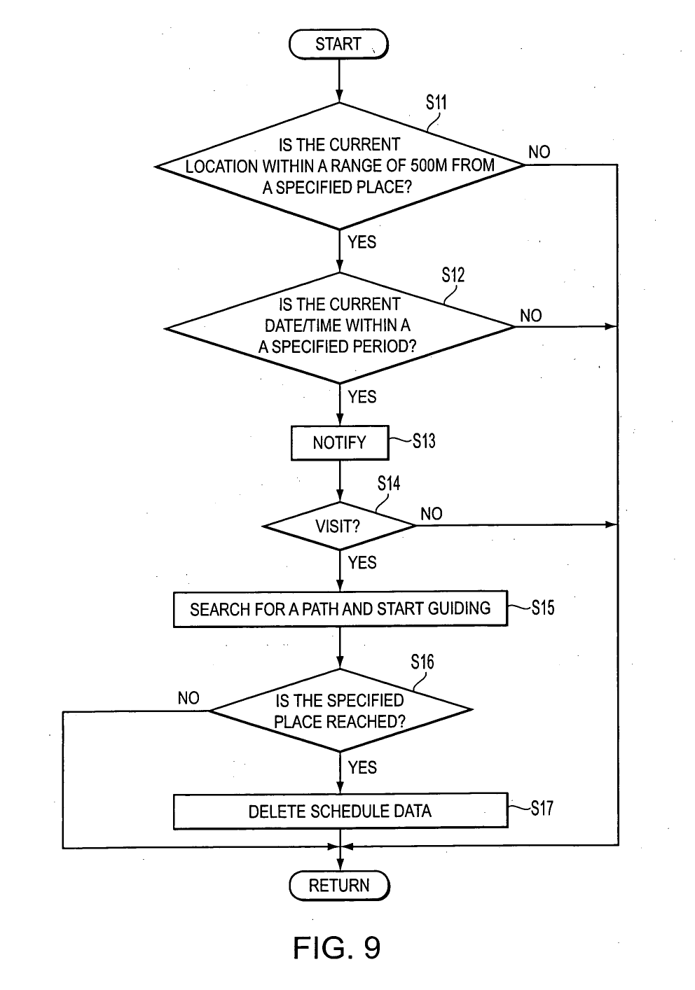

FIG. 9 is a flow chart showing a process of informing the user of a registered schedule, according to the fourth embodiment of the present invention.

In this exemplary embodiment, when a specified point is located within a predetermined range from the current position of the information terminal 12a, the specified point is displayed on the display of the information terminal 12a, thereby notifying the user of the specified point. The notification may be performed by means of displaying the specified point on the display or by means of generating a voice or a particular sound, such as a music sound or a chime sound. In this embodiment, it is assumed that the notification is performed by means of displaying the specified point on the display of the information terminal 12a. The range may be specified by a radius of N km from the current position, wherein the value of N can be properly set by the user within a wide range from a small value to a large value. This allows the user to detect the specified point located within the range that can be set to an arbitrary value.

Instead of the current position of the information terminal 12a, the user may specify a registered position or a particular position on a map as the reference position of the range so that the user can recognize a specified point in a region around the specified reference position. In other words, when the user detects a specified point in a region around the current position, the user can arbitrarily set the current position. This makes it possible for the user to easily detect a specified point in a region around an arbitrarily selected position other than the actual current position. In the following explanation, it is assumed by way of example that the actual current position of the information terminal 12a is selected as the current position, and that N is set to 0.5 km so that a specified point located within a region with a radius of 500 m from the current position of the information terminal 12a is displayed on the display of the information terminal 12a.

If it is determined that the specified point is located within the region with the radius of 500 m from the current position of the information terminal 12a, it is further determined whether the current date/time is within a period of time specified and registered in advance by the user as a period in which notifying of a registered schedule is to be performed. In the case in which it is determined that the current date/time is within the specified period of time, the specified point is displayed on the display of the information terminal 12a, thereby notifying the user of the specified point. Thus, the user can easily recognize that the user should visit the specified point. Even when the specified point is located within the region with the radius of 500 m from the current position, if the current date/time is not within the specified period of time, the specified point is not displayed on the display of the information terminal 12a.

When the specified point is displayed on the display of the information terminal 12a, thereby notifying the user of the specified point, visit selection buttons serving as selection means for selecting whether to visit the specified point are also displayed on the display. The visit selection buttons include a visit button that is clicked when the user decides to visit the specified point and a don't-visit button that is clicked when the user decides not to visit the specified point. That is, the user clicks either the visit button or the don't-visit button to select whether to visit the specified point. Note that the visit selection button may be formed in a single button. In this case, if the visit selection button is clicked, it is determined that the user has decided to visit the specified point.

If information indicating that the user has decided to visit the specified point is transmitted from the information terminal 12a to the information provider server 11, the route searching unit 24 starts to search for a route from the current position to the specified point set as the destination. After completion of searching, route information and route guide information are transmitted from the transmitter/receiver unit 14 of the information provider server 11 to the information terminal 12a, and the information terminal 12a performs guiding of the determined route. More specifically, the information terminal 12a displays the route to the specified point on the display on the basis of the received route information and route guide information and starts to guide the user along the route. In the case in which the user selects not to visit the specified point, neither searching for the route nor the guiding of the route is performed.

Thereafter, it is determined whether the specified point set as the destination has been reached, on the basis of the current position of the information terminal 12a. If it is determined that the specified point has been reached, schedule data associated with visiting the specified point is deleted from the file. In the case in which it is determined that the specified point has not yet been reached, the above-described process is repeated without deleting the schedule data.

The process is described in further detail below with reference to the flow chart shown in FIG. 9.

Step S11. It is determined whether the current position is within a range of 500 m from the specified point. If it is determined that the current position is within the range of 500 m, the process proceeds to step S12. However, the process is ended if it is determined that the current position is not within the range of 500 m.

Step S12. It is determined whether the current date/time is within a specified period. If the current date/time is within the specified period, the process proceeds to step S13. If the current date/time is not within the specified period, the process is ended.

Step S13. The user is notified of the specified point.

Step S14. The user decides whether to visit the specified point. If the user selects to visit the specified point, the process proceeds to step S15. However, the process is ended if the user selects not to visit the specified point.

Step S15. A route is searched for, and guiding is started.

Step S16. It is determined whether the specified point has been reached. If it is determined that the specified point has been reached, the process proceeds to step S17. However, the process is ended if it is determined that the specified point has not been reached.

Step S17. The schedule data is deleted from the file.

In the exemplary embodiment as described above, if the information terminal 12a enters a predetermined range from a specified point registered as a destination, the user is notified that the specified point is located within the predetermined range, thereby ensuring that the user can behave according to the schedule.

A fifth exemplary embodiment of the present invention is described below. Description of configuration and operation same or similar to those of the first to fourth embodiments is omitted.

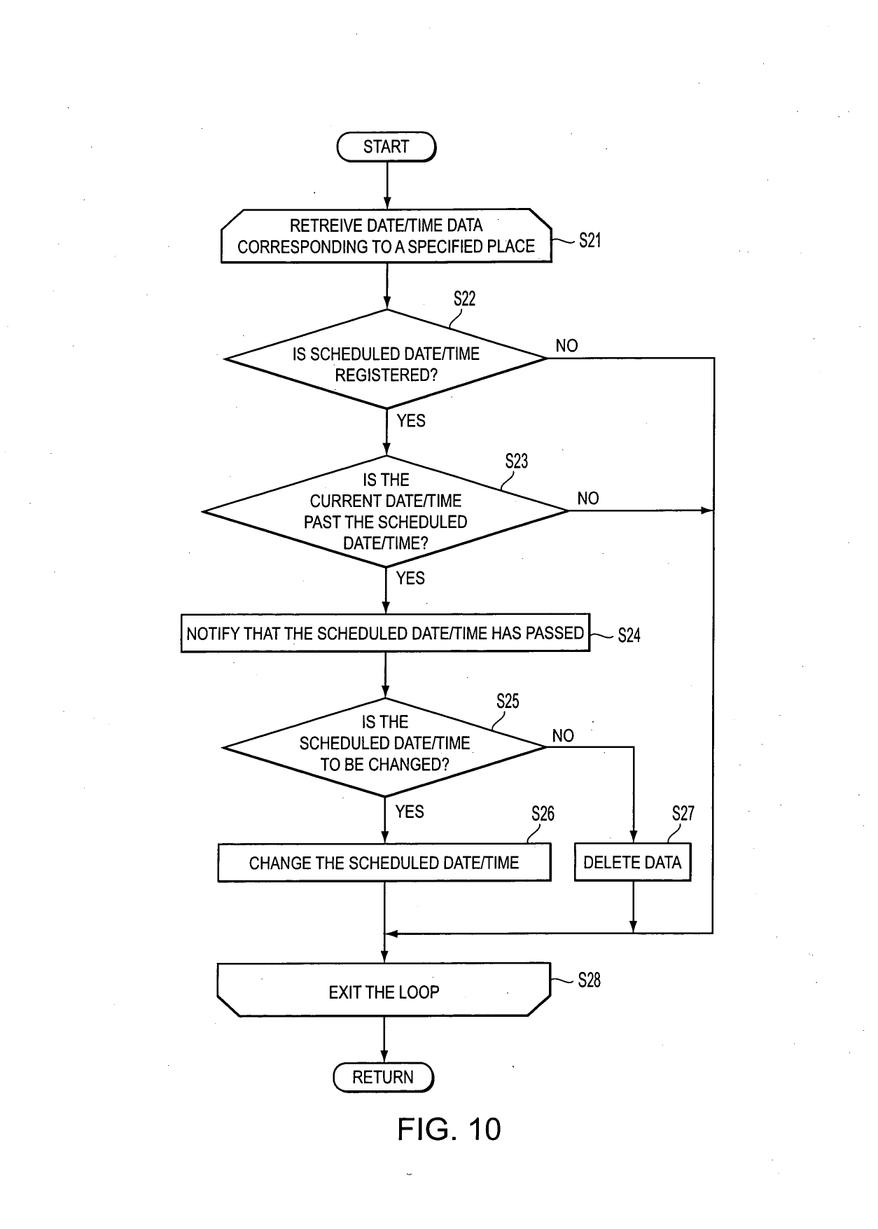

FIG. 10 is a flow chart showing a process of changing a registered scheduled date/time according to the fifth exemplary embodiment of the present invention.

In this embodiment, a process performed when a scheduled date/time has lapsed is described. Herein, it is assumed that date/time data indicating the scheduled date/time has been registered in a personal file corresponding to a user.

First, the PIM processor 25 searches for date/time data corresponding to a specified point registered in the personal file corresponding to the user. The searching for date/time data is performed sequentially for all specified points included in the schedule registered in the personal file corresponding to the user. The PIM processor 25 then determines whether date/time data indicating a scheduled date/time at which to visit the specified point is registered, i.e., the PIM processor 25 determines whether a scheduled date/time is registered. If it is determined that no scheduled date/time is registered, the PIM processor 25 searches for date/time data corresponding to a next specified point.

In the case in which it is determined that a registered scheduled date/time is detected, the PIN processor 25 further determines whether the current date/time is past the scheduled date/time. If it is determined that the current date/time is not past the scheduled date/time, the PIM processor 25 searches for date/time data corresponding to a next specified point. In the case in which the current date/time is past the scheduled date/time, information indicating that the scheduled date/time has lapsed is transmitted from the information provider server 11 to the information terminal 12a. In response, information indicating that the scheduled date/time has lapsed is displayed on the display of the information terminal 12a, thereby notifying the user that the scheduled date/time has lapsed. The notification may be performed by displaying the information on the display or by generating a voice or a sound such as a music sound or a chime sound. Herein, it is assumed by way of example that notification is performed by displaying the information on the display of the information terminal 12a.

When the information indicating that the scheduled date/time has lapsed is displayed on the display of the information terminal 12a to notify the user, scheduled date/time change buttons, serving as selection means for selecting whether to change the scheduled date/time, are also displayed on the display. The scheduled date/time change buttons include a change button used to select to change the scheduled date/time and a don't-change button used to select not to change the scheduled date/time. That is, the user can select whether to change the scheduled date/time by clicking the change button or the don't-change button. Note that the scheduled date/time change button may be formed in a single button. In this case, if the scheduled date/time change button is clicked, it is determined that the user has decided to change the scheduled date/time. When the user has selected to change the scheduled date/time, the user inputs a new scheduled date/time.

If information indicating that the scheduled date/time should be changed and information indicating the new scheduled date/time specified by the user are transmitted from the information terminal 12a to the information provider server 11, the PIM processor 25 changes the registered scheduled date/time to the new scheduled date/time specified by the user. After completion of changing the scheduled date/time, the PIM processor 25 searches for date/time data corresponding to a next specified point.

On the other hand, in the case in which information indicating that the user has selected not to change the scheduled date/time is transmitted from the information terminal 12a to the information provider server 11, the PIM processor 25 deletes registered schedule data associated with the specified point, i.e., the schedule data that has expired. After completion of deleting the data, the PIM processor 25 searches for date/time data corresponding to a next specified point.

The process is described in further detail below with reference to the flow chart shown in FIG. 10.

Step S21. A processing loop is started to sequentially search for date/time data corresponding to specified points.

Step S22. It is determined whether a scheduled date/time is registered. If a registered scheduled date/time is detected, the process proceeds to step S23. However, the process jumps to step S28 if no registered scheduled date/time is detected.

Step S23. It is determined whether the current date/time is past the scheduled date/time. If the current date/time is past the scheduled date/time, the process proceeds to step S24. However, the process jumps to step S28, if the current date/time is not past the scheduled date/time.

Step S24. A notification that the scheduled date/time has been passed is issued.

Step S25. It is determined whether the scheduled date/time is to be changed. If it is determined that the scheduled date/time is to be changed, the process proceeds to step S26. However, the process proceeds to step S27, if it is determined that the scheduled date/time is not changed.

Step S26. The scheduled date/time is changed.

Step S27. Data is deleted.

Step S28. The process exits the loop.

In the exemplary embodiment, as described above, a schedule is automatically deleted when a corresponding scheduled date/time has lapsed. This prevents the memory resource of the personal file of the user from being used to store unnecessary information.

As will be understood from the foregoing description, the present invention makes it possible to automatically acquire necessary information from a facility information screen, and to register the acquired information.

Furthermore, while the present disclosure describes certain preferred embodiments for use in Japan, it will be readily apparent to one having ordinary skill in the art that the invention is easily adaptable for use in other countries.

Although the present invention has been described above with reference to preferred embodiments, the present invention is not limited to those specific embodiments, but various modifications are possible without departing from the spirit and scope of the invention which is limited solely by the appended claims.

What is claimed is:

1. An information display system, comprising:
a display for displaying a facility information screen;
an information extractor for extracting position identification information from said facility information screen;
a search unit for searching for a facility corresponding to said position identification information;
a facility information registration unit for registering facility information including the position of the searched facility; and
a facility information storage unit for storing the registered facility information.

2. An information display system according to claim 1, further comprising:
an information terminal including said display and a transmitter/receiver unit; and
a server including said information extractor, said search unit, said facility information registration unit, said facility information storage unit, and a transmitter/receiver unit.

3. An information display system according to claim 1, comprising an information terminal including said display, said information extractor, said search unit, said facility information registration unit, and said facility information storage unit.

4. An information display system according to claim 1, wherein said position identification information includes at least one of a telephone number and an address, and said facility information registration unit verifies the consistency between the at least one of the telephone number and the address and sets the position of the facility depending on the result of the verification of the consistency.

5. An information display system according to claim 1, wherein the facility information includes a schedule in terms of a scheduled date/time.

6. An information display system according to claim 5, wherein a notification of the facility information is given in advance.

7. An information display system according to claim 5, wherein the schedule is deleted when the scheduled date/time expires.

8. An information display system according to claim 5, wherein the schedule is updated when the scheduled date/time expires.

9. An information display system according to claim 2, wherein said position identification information includes at least one of a telephone number and an address, and said facility information registration unit verifies the consistency between the at least one of the telephone number and the address and sets the position of the facility depending on the result of the verification of the consistency.

10. An information display system according to claim 3, wherein said position identification information includes at least one of a telephone number and an address, and said facility information registration unit verifies the consistency between the at least one of the telephone number and the address and sets the position of the facility depending on the result of the verification of the consistency.

11. An information display system according to claim 2, wherein the facility information includes a schedule in terms of a scheduled date/time.

12. An information display system according to claim 3, wherein the facility information includes a schedule in terms of a scheduled date/time.

13. An information display system according to claim 4, wherein the facility information includes a schedule in terms of a scheduled date/time.

14. An information display system according to claim 6, wherein the schedule is deleted when the scheduled date/time expires.

15. An information display system according to claim 6, wherein the schedule is updated when the scheduled date/time expires.
